(19) United States
(12) Patent Application Publication
(10) Pub. No.: US 2007/0047733 A1
(43) Pub. Date: Mar. 1, 2007

(54) System and Method for Premises End Crosstalk Compensation

(76) Inventors: Gordon Bremer, Largo, FL (US); Ramon B. Hazen, N. Redington Beach, FL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/464,597

(22) Filed: Aug. 15, 2006

Related U.S. Application Data
(63) Continuation of application No. 09/645,206, filed on Aug. 25, 2000, now abandoned.
(60) Provisional application No. 60/170,882, filed on Dec. 15, 1999.

(51) Int. Cl. H04M 1/76

(52) U.S. Cl. 379/416

(57) ABSTRACT

A crosstalk compensator provides for the compensation of mismatches in mutual coupling capacitances between adjacent parallel wire pairs. The aforementioned mismatch in mutual coupling capacitance may arise in a customer premises wiring system which may consist of at least the drop cable, cable run and/or receiver cable (from the service drop point to a digital device). Mismatches in the mutual coupling capacitances in the customer premises wiring system may give rise to undesirable levels of premises end crosstalk (PEXT) interference for which the crosstalk compensator has been designed to mitigate by providing a system and method for the connection of compensating capacitors between pairs of conductors selected from the plurality of subscriber loop conductors such that the mismatch is reduced or eliminated. The crosstalk compensator may be implemented in a variety of formats, including firmware or program code residing on a computer-readable medium, hardware, or a combination thereof.

### CLAIM OF PRIORITY

This application is a continuation of U.S. patent application Ser. No. 09/645,206, filed Aug. 25, 2000, which claims priority to U.S. provisional application entitled, “Premises End Crosstalk Compensator,” assigned Ser. No. 60/170,882, filed Dec. 15, 1999. Both applications are fully incorporated herein by reference.

### TECHNICAL FIELD

The present invention is generally related to the field of communications and, more particularly, to a crosstalk compensator which eliminates or reduces interfering signals, such as premises end crosstalk (PEXT) interference, in a subscriber loop caused by portions of the transmission system between the service drop point and a communication device.

### BACKGROUND OF THE INVENTION

With the increasing bandwidth demands from the advent of the Internet, service providers have been looking for ways to increase data transmission performance over the copper wire local loop transmission lines that connect the telephone central offices (COs) to the customer premises (CP). The customer premises equipment (CPE) is connected to the CO switches over the above mentioned transmission lines known as “local loops,” “subscriber loops,” “loops,” “twisted wire pairs,” or the “last mile” of the telephone network. Historically, the public switched telephone network (PSTN) evolved with subscriber loops connected to a telephone network with circuit-switching capabilities that were designed to carry analog voice communications. Digital service provision to the CP is a more recent development. With it, the telephone network has evolved from a system capable of only carrying analog voice communications into a system which can simultaneously carry voice and digital data signals.

Because of the prohibitive costs of replacing or supplementing existing subscriber loops, technologies have been implemented that utilize existing subscriber loops to provide easy and low cost migration to digital technologies. Subscriber loops capable of carrying digital data signals are known as digital subscriber lines (DSLs). Logical channels within a subscriber line which carry digital data signals are known as DSL channels, while logical channels within a subscriber line which carry plain old telephone service (POTS) analog signals are known as POTS channels. Some DSL technologies, such as, but not limited to, integrated services digital network (ISDN), high-bit-rate digital subscriber line (HDSL), HDSL2 and symmetric digital subscriber line (SDSL), may utilize portions of the POTS channel and therefore do not coexist with a POTS signal. Other well known digital technologies provide customers with additional flexibility and enhanced services by utilizing frequency-division multiplexing and/or time-division multiplexing and modulation techniques to fully exploit a subscriber loop with multiple logical channels. These newer multiple channel DSL technologies provide digital service to the customer premises without significantly interfering with the existing POTS equipment and wiring. The newer DSL technologies accomplish this functionality by frequency-division multiplexing (FDM) their digital data signal above (at higher frequencies than) the 0 KHz to 4 KHz frequency range, within which standard analog POTS signals are carried. Modulation schemes used to communicate between CO 122 and CP 124 (see FIG. 1) may include, but are not limited to, carrierless amplitude/phase modulation (CAP), quadrature amplitude modulation (QAM), Discrete Multi Tone (DMT) or pulse amplitude modulation (PAM), and are commonly known in the art. Multiplexing and modulation techniques and terminology are known to those skilled in the art, and are not described herein.

Several variations of new multiple channel DSL technology exist, such as, but not limited to, Asymmetric Digital Subscriber Line (ADSL), Rate Adaptive Digital Subscriber Line (RADSL), Very High Speed DSL (VDSL), Multiple Virtual Lines (MVL™) and Tripleplay™, with this group generally referred to as xDSL. Communication systems carrying xDSL may multiplex xDSL signals and a POTS signal onto a single physical local loop. Typically, an individual subscriber loop consists of two copper wires insulated from each other and bound together either in a common wire bundle of a plurality of subscriber loops or bound together into a single cable. For convenience, subscriber loops residing in the CP have been traditionally made with two subscriber loops, that is four copper conductors, bound together into a single four wire cable which is run throughout the customer premises to provide POTS telephony service Also, 3-pair wires are very common, with the third pair seldom used. These four conductors may or may not be twisted together when formed into a single cable.

Although the transmission of both digital data signals and analog POTS signals over a subscriber loop offers many potential advantages for customers, several practical problems must be solved when implementing DSL solutions. One significant problem is the coupling of high-frequency signals into a DSL channel from adjacent subscriber loops. These coupled signals may interfere with the decoding of a received digital data signal. This mechanism of signals on adjacent channels interacting is called crosstalk.

Crosstalk herein is defined as the presence of interfering signals in a differential wire pair caused by adjacent parallel subscriber loops (pairs of electrical conductors) residing in the same cable bundle or binder. The most commonly known forms of crosstalk have been categorized into two types: near end crosstalk (NEXT) and far end crosstalk (FEXT). NEXT is significant because the high energy digital data signal from an adjacent system can induce relatively significant crosstalk into the primary digital data signal. FEXT is typically less of an issue because the far end interfering digital data signal is attenuated as it traverses the loop. These two forms of well known crosstalk are a dominant factor in the performance of many systems. The telephone company's bulk transmission line (130) has been designed and implemented to mitigate the impact of NEXT and FEXT such that multiple DSL transmissions can operate at an acceptable level of efficiency when communicating on adjacent loops.

Another source of crosstalk may arise from the wiring between the cable-drop point and the communication device, such as a digital receiver/transmitter. As will be described in detail hereinafter, this portion of the wiring may consist of at least the drop cable, which connects the bulk transmission line to the CP, the cable run and the receiver cable, defined hereinafter as the premises wiring system. Crosstalk induced by this portion of a subscriber loop is defined hereinafter as premises end crosstalk (PEXT) interference. PEXT interference may become significant when there are two digital receiver/transmitters located within the CP utilizing approximately the same transmission frequency, and if the two digital receiver/transmitters are connected to subscriber loops having conductors which are adjacent to each other and parallel with each other over some portion of the premises wiring system. The high frequency transmission of the digital data signal creating the crosstalk is often referred to as the disturber, and the received digital data signal in the subscriber loop subjected to the crosstalk is often referred to as the victim. PEXT interference is not typically significant when the potential disturber is transmitting/receiving at frequencies that are different from the victim, such as might be the case of a low frequency POTS signal interfering with a high frequency digital data signal, or two high frequency digital data signals using substantially different frequency bandwidths.

FIG. 1 is a simplified illustrative schematic view of a prior art communication network 120 showing a CO 122 connected to a CP 124 via two subscriber loops 126 and 128. Typically, many individual subscriber loops are bundled together at convenient locations into one bulk transmission line 130 which extends out from the CO into the service area where a plurality of CPs are located. The bulk transmission line may be an overhead line or an underground cable, or a mixed combination of both overhead and underground. The close proximity of the many subscriber loops to subscriber loops 126 and 128 may result in the above-described undesirable FEXT and NEXT interference.

At various points along the bulk transmission line 130 individual subscriber loops, or groups of subscriber loops, are split off from the bulk transmission line 130 and run to the CP 124, known as a drop cable 132. The drop cable 132 may be either overhead or underground. In the simplified illustrative example shown in FIG. 1, the drop cable 132 is shown as splitting away from the overhead bulk transmission line 130 at telephone pole 134 and entering the CP 124 at the service entrance point 136.

At the service entrance point, the subscriber loops are typically further separated into a plurality of individual cable runs which terminate at predetermined convenient locations. For example, if the CP 124 was a residential home, the cable runs may go to the kitchen, office, living room, hallway and/or bedrooms where the homeowner would want to connect a telephone or a personal computer (PC). If the CP 124 was an office or other large complex, the cable run may connect to individual offices or other locations, or connect into a local area network (LAN) or the like.

In the simplified illustrative example of a CP 124 shown in FIG. 1, two subscriber loops 126 and 128 are shown. Subscriber loop 126 provides a connection point 140 so that the user may connect a device into the network. In a residential home, connection point 140 may be the well known telephone jack or telephone outlet. Here, a telephone 142 having a filter 146 is connected into the network 120 via line 148 at the connection point 140. (Telephone filter 146 may not be required in some systems, or may be integrated into the telephone 146 itself.) Subscriber loop 126 then continues on through cable run 138 to connection point 150.

Digital device 152 connects to subscriber loop 126 at connection point 150 via line 154. Digital device 152 would receive digital data signals from network 120 and/or transmit digital data signals into the network 120. Digital device 152 decodes digital data signals received from the digital equipment 158 over subscriber loop 126 into a format compatible with the device to which it is connected to, such as the PC 154. Digital device 152 also encodes digital data received from the PC 154 into a digital data format for transmission to digital equipment 158. A non-limiting simplified example of digital device 152 shown in FIG. 1 is a modem. Digital device 152 is shown as providing connectivity for PC 154 to the network 120 and resides outside PC 154 as a stand-alone device for convenience. However, digital device 152 may reside inside PC 154 as an add-on device, or may be incorporated inside PC 154 as an integral functioning part of PC 154. Digital device 152 may also be any type of device which transmits and/or receives digital data signals from the network 120. Another illustrative example of a digital device (not shown) could be an interface device between a frame relay access unit (FRAU) connecting to network 120 and a LAN residing in the CP. As will be described hereinafter, any plurality of devices, analog or digital, communicating at the same frequencies may be subject to PEXT interference.

FIG. 1 shows three communication equipment components of the telephony system CO 122; the POTS switching equipment 156, digital equipment 158 and the POTS splitter 160. More communication equipment components would likely be located at the CO 122, but are not shown in FIG. 1 for simplicity and convenience. POTS switching equipment 156 receives telephone signals from and transmits telephone signals into network 120. Digital equipment 158 receives data signals from and transmits data signals into network 120. A POTS splitter 160 is typically used to provide interfacing for the POTS switching equipment 156 and digital equipment 158 onto the same subscriber loop 126. As is well known in the art, the telephony signal transmitted to/from the telephone 142 over subscriber loop 126 is transmitted without significantly interacting with or interfering with the data transmissions from digital device 152 because the telephone signal multiplexed onto subscriber loop 126 is transmitted on a different (typically lower) frequency than the data signal frequency associated with digital device 152.

In the simplified illustrative example shown in FIG. 1, a second subscriber loop is shown providing connectivity between digital device 162, located at CP 124, and digital equipment 164, located at CO 122. Subscriber loop 128 terminates at connection point 166. Line 168 connects digital device 162 to subscriber loop 128 at connection point 166, thereby connecting PC 170 to the network 120.

The simplified illustrative example of FIG. 1 illustrates two portions of the network 120 where PEXT interference may arise. Subscriber loops 126 and 128 both reside in drop cable 132. Also subscriber loops 126 and 128 reside in cable run 138. Under certain conditions, the electromagnetic coupling between the pair of conductors in subscriber loop 126 and the pairs of conductors in subscriber loop 128, as described hereinafter, may be such that PEXT interference may be induced into either of the conductors of subscriber loop 126 or subscriber loop 128. A third source of PEXT interference may also arise if lines 154 and 168 are bound together into a single cable (not shown), such as a typical four wire telephone cable or a cable bundle extending to a plurality of work stations in an office.

FIG. 2 is a circuit diagram of the portions of the two subscriber loops 126 and 128 (see also FIG. 1) showing an equivalent circuit model of the mutual coupling capacitances between the two pairs of conductors (line 1, line 2, line 3 and line 4) which may give rise to PEXT interference. As is well known in the art, an electrical conductor generates a electromagnetic field when voltage is applied to or current passes down the conductor. When two electrical conductors are in parallel with each other, and in sufficient proximity to each other, the signal in the first conductor may induce a signal into the second conductor. This effect has been modeled in the art with the use of a single capacitive value, which is designated as a mutual coupling capacitance. The simplified circuit diagram of FIG. 2 shows how the mutual coupling capacitive effect between a plurality of parallel conductors may be viewed. In FIG. 2, the mutual compensating capacitors C13, C14, C23 and C24 are intended to represent the mutual coupling capacitances associated with the customer premises wiring system portion of subscriber loops 126 and 128 which may give rise to PEXT interference. The mutual coupling capacitances of subscriber loops 126 and 128 (FIG. 1), and the adjacent subscriber loops in the bulk transmission line 130 (FIG. 1), which gives rise to NEXT and FEXT is not intended to be represented by the mutual compensating capacitors C13, C14, C23 and C24 shown in FIG. 2.

Digital equipment 164 is connected to digital device 162 by subscriber loop 128, which has two conductors (line 1 and line 2). The mutual coupling capacitance between line 1 and line 2 is shown by the mutual coupling capacitor C12, where the letter “C” indicates a capacitor and the numerals “12” correspond to line 1 and line 2, respectively. Similarly, digital equipment 158 is connected to digital device 152 by subscriber loop 126, which has two conductors (line 3 and line 4). The mutual coupling capacitances between line 3 and line 4 is modeled by mutual coupling capacitor C34.

In the simplified illustrative example of FIG. 2, line 1 and line 2 are the two electrical conductors which form subscriber loop 128 (see also FIG. 1). Line 3 and line 4 are the two electrical conductors which form subscriber line 126. As is well known in the art, all subscriber loops are made of pairs of wires like those shown in FIG. 2.

Also shown in FIG. 2 at the terminal ends of each line pair, is a resistor Rₜ, where the letter “R” denotes a resistive impedance and the letter “t” denotes a terminal location. Rₜ terminates the end of the transmission line in its characteristic impedance, to minimize reflections of the signal.

When subscriber lines are bundled together into the drop cable 132 (FIG. 1) or the cable run 138, the electrical conductors of the two subscriber loops 126 and 128 are parallel to and in close proximity to each other. The signal present on one subscriber loop may induce a signal in the conductors of the adjacent subscriber loop. This induced signal may create undesirable interference in digital data signals being transmitted over the second subscriber loop, known herein as PEXT interference.

In the simplified illustrative example of FIG. 1, two subscriber loops 126 and 128 are shown to provide connection to digital devices 152 and 162 to the central office digital equipment 158 and 164, respectively. When the four electrical conductors, line 1, line 2, line 3 and line 4, are bundled together, each line will be capacitively coupled to some degree with each of the other lines. The degree of capacitive coupling will be, in part, a function of the proximity of each electrical conductor with the other electrical conductors. Thus, line 1 will be capacitively y coupled to line 2 by C12 (using the nomenclature as described above for C12), capacitively coupled with line 3 through C13, and capacitively coupled with line 4 through C14. Here, C12 also represents the capacitive coupling of line 2 with line 1. C13 also represents the capacitive coupling of line 3 with line 1 (FIG. 1) and, C14 also represents the capacitive coupling of line 4 with line 1. Line 2 is capacitively coupled to line 3 and line 4 of subscriber loop 126 through C23 and C24, respectively.

As is well known in the art, when mutual coupling capacitor C14 is equal to C24, the signals induced into line 4 by line 1 (through C14) and by line 2 (through C24) will be equal in magnitude but opposite in phase, thereby canceling each other, resulting in no net induced signal in line 4. That is, when C14 equals C24, there will be no net signal induced from subscriber loop 128 onto line 4 of subscriber loop 126, and therefore, no interference. Similarly, if C13 equals C23, transmissions over subscriber loop 128 will induce no interfering signal in subscriber loop 126, line 3.

In the special situation when C14 equals C24 and C13 equals C23, there will be no PEXT interference induced by subscriber loop 128 onto subscriber loop 126. Also, there will be no signal induced from subscriber loop 126 onto subscriber loop 128 if C13 equals C14 and C23 equals C24. If C13 does not equal C14 and/or C23 does not equal C24, then subscriber loop 126 will induce signal into subscriber loop 128 in a manner described hereinafter. Similarly, if C13 does not equal C23 and/or C14 does not equal C24, then subscriber loop 128 will induce signal into subscriber loop 126 in a manner described hereinafter.

In the special situation where C13 equals C14 equals C23 equals C24, there will be no induced signal in subscriber loop 128 caused by a subscriber loop 126, and no induced signal in subscriber loop 126 caused by subscriber loop 128. That is, there will be no PEXT interference between the two subscriber loops 126 and 128.

The process by which digital transmission in a subscriber loop may induce undesirable signal in the conductors of adjacent parallel subscriber loops will now be described in detail. When C14 does not equal C24, transmissions across subscriber loop 128 will induce undesirable signal into subscriber loop 126, line 4, and may result in undesirable levels of PEXT interference. Likewise, if C13 does not equal C23, transmissions across subscriber loop 128 may induce undesirable PEXT interference in subscriber loop 126, line 3. These undesirable induced signals, known hereinafter as PEXT interference, may result in interference with the decoding of transmission of digital data signals across subscriber loop 126. The interference may be of such a magnitude that decoding errors may occur in digital device 152 as it is decoding received digital data signals from digital equipment 158.

Subscriber loop 126 may similarly induce undesirable levels of PEXT interference into line 1 of subscriber loop 128 if C13 does not equal C14. If C23 does not equal C24, subscriber loop 126 may induce undesirable levels of PEXT interference into line 2 of subscriber loop 128. In some situations, the induced PEXT interference from subscriber loop 126 into subscriber loop 128 may cause decoding errors by digital device 162.

The communications industry has taken some measures to mitigate the impact of PEXT interference. One common method utilized by the communications industry is to manufacture modem customer premises multi-pair cable in such a manner as to minimize PEXT interference. One technique is to manufacture the conductors twisted together with predetermined twist rates that minimize PEXT interference. However, older conductors manufactured prior to the advent of digital communication technologies were not manufactured with predetermined twist rates, because PEXT interference was not a design issue. Even with the newer conductors, it is often the case that there will be some level of PEXT interference present in the system due to, for example but not limited to, terminal equipment attachment leads. PEXT interference may be a significant problem in older CP 124 (FIG. 1) wiring networks or in older office building complexes which were constructed prior to the advent of digital communication technologies. In these older facilities, manufacture of telephone wire was not done in a manner which mitigates PEXT interference.

Thus, it is seen that in prior art systems, particularly in older CP facilities, PEXT interference may be a significant source of crosstalk and may result in interference in the decoding of digital transmission digital data signals. Thus, a heretofore unaddressed need exists in the industry for a way to reduce PEXT interference, and thereby mitigate this type of crosstalk interference.

### SUMMARY OF THE INVENTION

The present invention provides a crosstalk compensator system and method for the compensation of mismatches in mutual coupling capacitances between adjacent parallel subscriber loops. The aforementioned mismatch in mutual coupling capacitance may arise in the customer's premises wiring system which may consist of the drop cable, cable run and/or receiver cable. Mismatches in the mutual coupling capacitances in the customer's premises wiring system may give rise to undesirable levels of premises end crosstalk (PEXT) interference for which the preferred embodiment of the crosstalk compensator has been designed to mitigate by providing a system and method for the addition of compensating capacitors such that the mismatch is reduced or eliminated.

The preferred embodiment of the crosstalk compensator has two groups, each group having three compensating capacitors. The compensating capacitors have switches such that, when connected in parallel with two subscriber loops that have a mismatch in their mutual coupling capacitances, one of more of the compensating capacitors may be connected such that the mismatch is reduced or eliminated, thereby reducing or eliminating the undesirable PEXT interference.

An alternative embodiment of the crosstalk compensator has a plurality of compensating capacitors. Another alternative embodiment has only one grouping of compensating capacitors. Another alternative embodiment has line switches such that the installer need only attach the crosstalk compensator to the subscriber loops, and then select switch positions to effect the desired connections. Other alternative embodiments of the crosstalk compensator include a processor controlling the switches and/or a detector which automatically detects the mismatch and provides the mismatch information for the processor such that the processor determines which compensating capacitors are to be switched.

Yet another embodiment of the crosstalk compensator employs a plurality of compensating capacitors, a plurality of compensating capacitor switches and line switches, a detector and a processor. The detector detects the mismatches, the processor determines the required amounts of compensation and the location of the compensation, and then implements the compensating capacitor switches and line switches such that the necessary groupings of compensating capacitors are made and connected in parallel with a plurality of subscriber loops.

Other alternative embodiments of the crosstalk compensator are implements in other types of communication networks where undesirable levels of PEXT-like interference is encountered. Communication devices creating PEXT-like interference and communication devices being interfered with may be either analog or digital communication devices.

The crosstalk compensator can be conceptualized as providing one or more methods for reducing or eliminating PEXT interference between adjacent parallel subscriber loops. In accordance with one method of the invention, the method may be broadly summarized by the following steps: connecting a compensating capacitor group to a pair of conductors; detecting said at least one mismatch between said plurality of mutual coupling capacitances; selecting at least one compensating capacitor residing in the compensating capacitor group; and switching the at least one compensating capacitor such that the compensating capacitor is connected in parallel with the pair of conductors to reduce the mismatch.

The crosstalk compensator may be implemented in a variety of formats, including firmware or program code residing on a computer-readable medium, hardware, or a combination of firmware and hardware.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The present invention, a crosstalk compensator, can be better understood with reference to the following drawings. The elements of the drawings are not necessarily to scale relative to each other, emphasis instead being placed upon clearly illustrating the principles of the crosstalk compensator. Furthermore, like reference numerals designate corresponding parts throughout the several views.

FIG. 1 is a block diagram of a simplified example of a prior art telephony system showing two subscriber loops from the central office (CO) to the customer premises (CP).

FIG. 2 is a circuit diagram of the two subscriber loops of FIG. 1 showing a circuit model of the mutual coupling capacitance which may give rise to PEXT crosstalk interference.

FIG. 3 is a block diagram of the prior art telephony system of FIG. 1 showing a possible installed location of the preferred embodiment of the crosstalk compensator.

FIG. 4 is a circuit diagram of the two subscriber loops of FIG. 2 illustrating connections of the preferred embodiment of the crosstalk compensator.

FIG. 5 is a circuit diagram of the two subscriber loops of FIG. 4 and the preferred embodiment of the crosstalk compensator with compensating capacitors.

FIG. 6 is a circuit diagram of the components of a preferred embodiment of the crosstalk compensator of FIG. 5.

FIG. 7 is a circuit diagram of the components of an alternative embodiment of the crosstalk compensator of FIG. 4.

FIG. 8 is a circuit diagram of the components of an alternative embodiment of the crosstalk compensator of FIG. 4 having two line selecting switches.

FIG. 9 is a circuit diagram of an alternative embodiment of the crosstalk compensator of FIG. 4 having processor controlled line switches.

FIG. 10 is a circuit diagram of an alternative embodiment of the crosstalk compensator of FIG. 4 having processor controlled line switches and compensating capacitor switches.

FIG. 11 is a circuit diagram of an alternative embodiment of the crosstalk compensator of FIG. 10 having a detector.

FIG. 12 is a circuit diagram of the components of an alternative embodiment of the crosstalk compensator of FIG. 4 having a plurality of compensating capacitors which are connected to subscriber loop conductors by a plurality of switches under the control of a processor and detector.

FIG. 13 is a circuit diagram of an alternative embodiment of the crosstalk compensator of FIG. 12 further modified to detect, determine and compensate crosstalk on a plurality of adjacent parallel subscriber loops.

FIG. 14 is a flow chart showing a method for selecting the compensating capacitors and for controlling the switching of the compensating capacitors of FIG. 13.

Reference will now be made in detail to the description of the crosstalk compensator as illustrated in the drawings. While the crosstalk compensator will be described in connection with these drawings, there is no intent to limit the crosstalk compensator to the embodiment or embodiments disclosed therein. On the contrary, the intent is to cover all alternatives, modifications and equivalents included within the spirit and scope of the crosstalk compensator as defined by the claims.

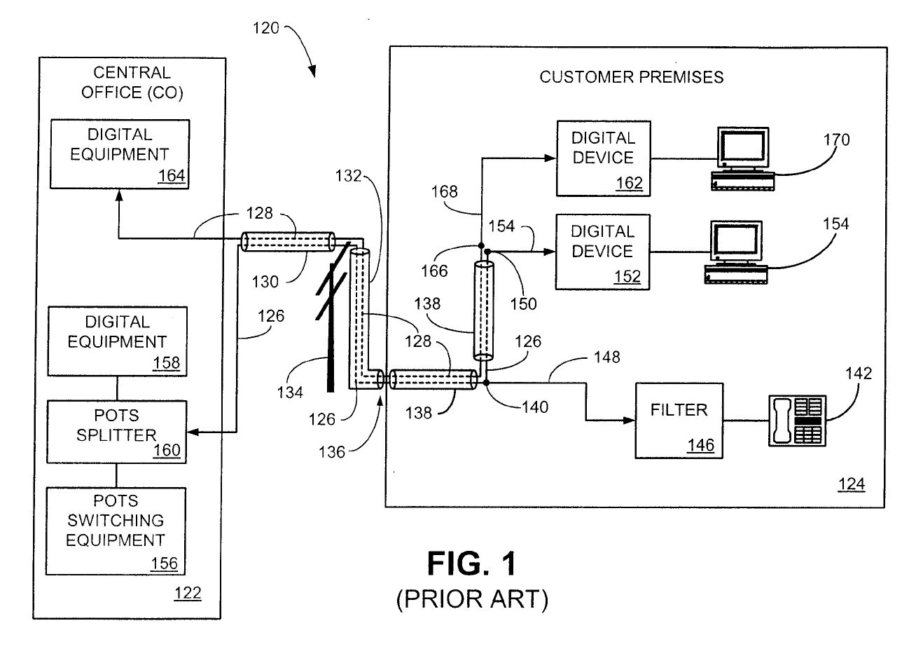

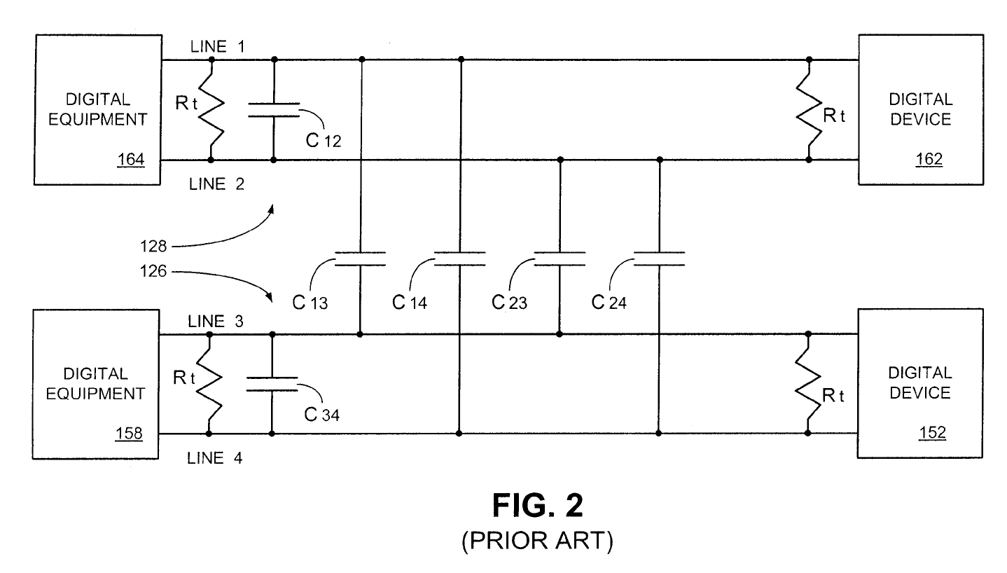

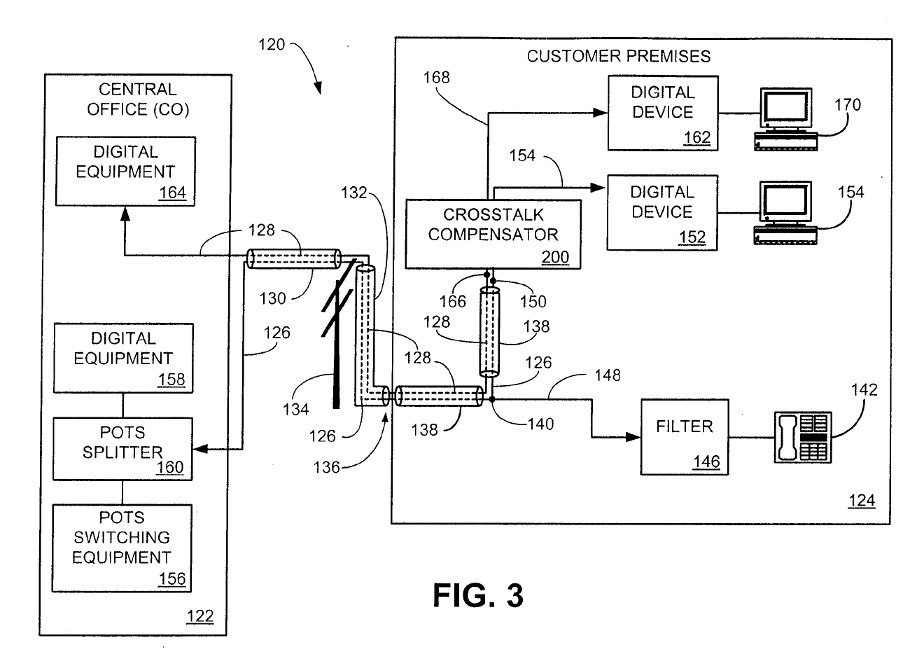

Furthermore, elements shown in the figures which are similar to each other will bear the same reference numerals. Elements in FIG. 3 that are similar to those in FIG. 1 bear the same reference numerals and may be considered to be like elements. Likewise, similar elements in FIGS. 2 and 4-14 may bear the same reference numerals. However, since these like numeral elements are incidental to the operation of the crosstalk compensator which is connected to an existing communication network, one skilled in the art will realize that the similar elements bearing the same reference numerals need not be identical, as any variation of such elements will not adversely affect the functioning and the performance of the crosstalk compensator which may be adjusted to accommodate for variations in any particular circuit in which the crosstalk compensator has been implemented, as will be described hereinbelow.

### DETAILED DESCRIPTION

### I. Communication Topology

The crosstalk compensator 200 of the present invention, generally denoted by reference numeral 200, is shown in the simplified illustrative example of FIG. 3 as connected to connection points 150 and 166, and lines 154 and 168. By connecting to connection point 150, the crosstalk compensator 200 becomes connected in series with digital device 152 and digital equipment 158 over subscriber loop 126. Similarly, by connecting to connection point 166 and line 168, the crosstalk compensator 200 is connected in series with digital device 162 and digital equipment 164 over subscriber loop 128. The location of the crosstalk compensator 200 as shown in FIG. 3 and as described above conveniently illustrates one possible connection location for the crosstalk compensator 200. The crosstalk compensator may be located elsewhere in the communication system, as long as the connections of the crosstalk compensator elements may be effected as described hereinafter. For example, an existing telephone jack (not shown) providing access to the above-described lines could be one possible alternative location for a crosstalk compensator 200.

As will be described hereinafter, the crosstalk compensator 200 as shown in FIG. 3, will filter out, remove, cancel and/or otherwise eliminate some or all of the PEXT interference which may be interfering with the receiving of digital data signals by digital devices 152 and 162. As noted hereinabove, the sources of PEXT interference arise from mismatches in the mutual coupling capacitive effect between subscriber loops 126 and 128 in the drop cable 132 and the cable run 138. Additionally, PEXT interference may also arise from any other portions of the premises wiring where subscriber loops 126 and 128 are run in parallel and in close proximity with each other, such as when subscriber loops 126 and 128 share a receiver cable (not shown) or are otherwise situated parallel to and in close proximity to each other.

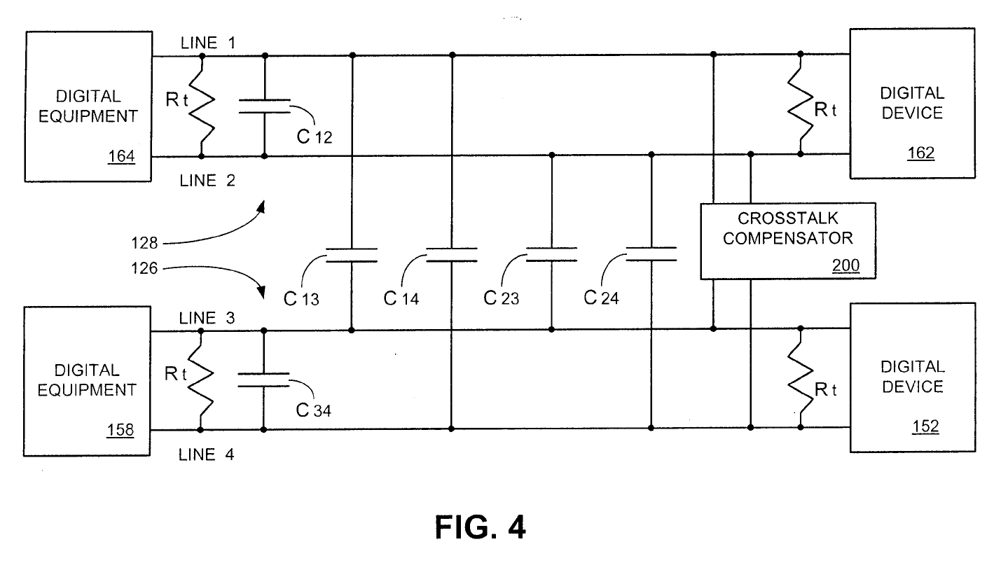

FIG. 4 is a circuit diagram of the two subscriber loops of FIG. 2 illustrating a possible connection of the preferred embodiment of the crosstalk compensator 200 to subscriber loops 126 and 128. FIG. 4 also includes a circuit model of the mutual coupling capacitance which may give rise to PEXT interference.

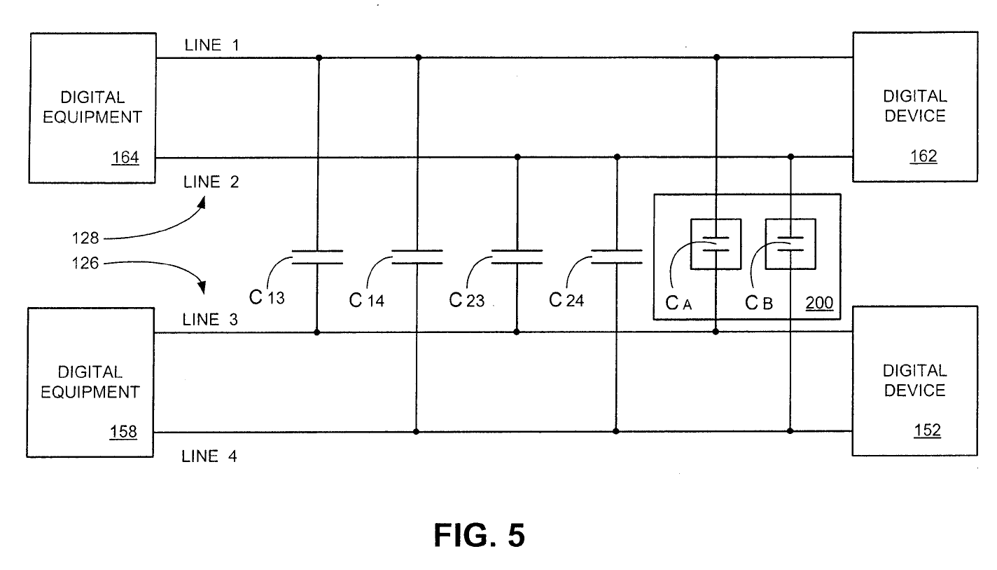

The preferred embodiment of the crosstalk compensator 200 illustrated in FIG. 4 is shown to be connected between line 1 of subscriber loop 128 and line 3 of subscriber loop 126, and connected between line 2 of subscriber loop 128 and line 4 of subscriber loop 126. With the location of the preferred embodiment of the crosstalk compensator 200 illustrated in FIG. 4, the crosstalk compensator 200 may be configured to compensate for PEXT interference which may be interfering in digital data signals received by digital device 152 and/or digital device 162. As previously described in the background section, undesirable levels of PEXT interference may arise due to mismatches in the mutual coupling capacitive effect between subscriber loops 126 and 128 which are adjacent and parallel to each other in the drop cable 132 and/or the cable run 138. The purpose of the particular configuration and connections illustrated in FIG. 4 will become apparent with the explanation of the preferred embodiment of the crosstalk compensator 200 as described for FIG. 5 hereinafter.

### II. Preferred Embodiment Overview

FIG. 5 shows a simplified illustrative example of the preferred embodiment of the crosstalk compensator 200. By way of a simple illustrative example describing the functioning of the crosstalk compensator 200, six non-limiting examples wherein subscriber loop 126 introduces PEXT interference into subscriber loop 128 will be described. That is, communications between digital equipment 158 and digital device 152 over subscriber loop 126 will be described as inducing PEXT interference into subscriber loop 128 such that transmissions from digital equipment 164 to digital device 162 may not be properly decoded, or received, by digital device 162. As described hereinabove, PEXT interference results from mismatches in the mutual coupling capacitance between subscriber loops 126 and 128.

The first illustrative example of the induction of PEXT interference into subscriber loop 128 by communications over subscriber loop 126 arises from the situation where C13 is less than C14. When C13 is less than C14, the signal induced by line 3 into line 1 through C13 would not equal the signal induced by line 4 into line 1 through C14. In this situation, the induced signals would not cancel each other and would result in a net signal induced into line 1 which may give rise to unacceptable levels of PEXT interference. The crosstalk compensator 200 provides a system and method for the effective compensation of the mutual coupling capacitances such that the coupling capacitance between line 3 and line 1 can be equalized (or nearly equalized such that PEXT interference does not interfere with digital data signal transmissions). PEXT interference may be mitigated by adding a parallel capacitive element, CA, such that the sum of C13 and CA equals C14. As is well known in the art, CA can be introduced in parallel with C13, and therefore added to C13, by connecting a capacitive element equal to CA between line 3 of subscriber loop 126 and line 1 of subscriber loop 128 as shown in FIG. 5.

One skilled in the art will appreciate that due to the manufacturing of capacitive elements into discreet sizes, that in a practical implementation of the crosstalk compensator 200, the selection of a capacitive element CA such that the sum of C13 and CA exactly equals C14 is not likely to be realized. At best, individual components which are used in the manufacture of a crosstalk compensator 200 would be selected such that CA could be determined in a manner explained hereinafter such that the sum of C13 and CA nearly equals or closely approximates C14. By judicious selection of the element CA, in a manner which minimizes the inequality of (C13+CA) and C14, the degree of PEXT interference may be reduced to a level that does not significantly interfere with digital data signal transmissions. This practical inability to exactly achieve equality is not seen to be detrimental to the benefit or the functionality of a crosstalk compensator 200 because, in the real life world, the objective of the crosstalk compensator 200 is to reduce levels of PEXT interference such that digital data signal transmissions are not unduly interfered with. For the convenience of providing an explanation of the functioning of the preferred embodiment of crosstalk compensator 200, and all of the alternative embodiments described hereinafter, the term “equals” will be used to denote an approximate equality of capacitive values such that PEXT interference is reduced to a level which does not significantly interfere with digital data signal transmissions. That is, when a statement such as “the sum of C13 and CA equals C14” is made, the use of the word “equals” is intended to mean “nearly equal” or “approximately equal” rather than “exactly equal.”

A second illustrative example of the induction of PEXT interference into subscriber loop 128 by communications over subscriber loop 126 arises from the situation where C14 is less than C13. This situation is analogous to the first situation described above except that the connection of the crosstalk compensator 200 would be altered such that CA will be connected between line 4 of subscriber loop 126 and line 1 of subscriber loop 128. This second situation is not described in detail nor shown by separate figure because one skilled in the art will realize this second situation is analogous to the first situation described hereinabove.

A third illustrative example in which PEXT interference may be induced into subscriber loop 128 by subscriber loop 126, can arise in the situation where C24 is less than C23. When C24 is less than C23, the signal induced by line 3 into line 2 through C23 would not equal the signal induced by line 4 into line 2 through C24. In this situation, the induced signals would not cancel each other and would result in a net signal induced into line 1 which may give rise to unacceptable levels of PEXT interference. The crosstalk compensator 200 provides a system and method for the effective compensation of the mutual coupling capacitances such that the coupling capacitance between line 3 and line 2 may be equalized (or nearly equalized) such that PEXT interference does not interfere with digital data signal transmissions. PEXT interference may be mitigated by adding a parallel capacitive element, CB, such that the sum of C24 and CB equals C23. As is well known in the art, CB can be introduced in parallel with C24, and therefore added to, by connecting a capacitive element equal to CB between line 4 and line 2 as shown in FIG. 5.

A fourth illustrative example of the induction of PEXT interference into subscriber loop 128 by communications over subscriber loop 126 arises from the situation where C23 is less than C24. This situation is analogous to the third illustrative example described above except that the connection of the crosstalk compensator 200 would be altered such that CA will be connected between line 3 of subscriber loop 126 and line 2 of subscriber loop 128 such that C23 plus CB equals C24 (or nearly equals). This fourth situation is not described in detail nor shown by separate figure because one skilled in the art will realize this fourth situation is analogous to the third illustrative example described hereinabove.

A fifth illustrative example in which subscriber loop 126 may induce signal into subscriber loop 128 occurs when C13 is unequal to C14 and C23 is unequal to C24. In this simplified illustrative example, wherein PEXT interference is induced from subscriber loop 126 into both lines 1 and 2 of subscriber loop 128, let C13 be less than C14 and let C24 be less than C23. In this fifth situation, PEXT interference can be mitigated by adding a parallel capacitive element CA, such that the sum of C13 and CA equals C14 and by adding a parallel capacitive element CB, such that the sum of C24 and CB equals C23. That is, CA is selected such that subscriber loop 126 does not induce unacceptable levels of PEXT interference onto line 1 of subscriber loop 128 and CB is selected such that subscriber loop 126 does not induce unacceptable levels of PEXT interference onto line 2 of subscriber loop 128. One skilled in the art will realize that the fifth illustrative example described hereinabove is simply a combination of the first and third illustrative examples described above. FIG. 5 illustrates the connections of the crosstalk compensator 200 which would insert CA in parallel with C13 and insert CB in parallel with C24.

A sixth illustrative example in which subscriber loop 126 may induce signal into subscriber loop 128 occurs when C14 is less than C13 and C23 is less than C24. One skilled in the art will realize that the sixth illustrative example described herein is simply a combination of the second and fourth illustrative examples described above. The connections of the crosstalk compensator 200 would be revised accordingly to the same connections of crosstalk compensator 200 as described for the second and fourth illustrative examples above.

One skilled in the art will appreciate that there are two additional situations, C13 less than C14 and C23 less than C24, and C14 less than C13 and C24 less than C23. These situations are merely combinations of the fifth and sixth illustrative examples, and thus are not described in detail nor shown by separate figure because the simple process of selecting the compensating capacitors and making the appropriate connections of the crosstalk compensator 200 are readily discernible by one skilled in the art.

Summarizing, the crosstalk compensator 200 as shown in FIG. 5 may be connected to subscriber loop 126 and subscriber loop 128 in any necessary manner so as to eliminate or substantially reduce unacceptable levels of PEXT interference induced into subscriber loop 128 by communications over subscriber loop 126.

One skilled in the art will appreciate that with the five situations described above wherein the mutual coupling capacitance of the lines (represented by C13, C14, C23 and C24) are unequal, data transmissions across subscriber loop 128 may similarly induce unacceptable levels of PEXT interference into subscriber loop 126. This situation may occur when C13 does not equal C23, and/or C14 does not equal C24. Because the situations here would be analogous to the five illustrative examples discussed above, and because one skilled in the art will appreciate that crosstalk compensator 200 may be configured to have the same canceling effect on PEXT interference induced into subscriber loop 126 by communications over subscriber loop 128, a detailed explanation of the connections of a crosstalk compensator 200 and the selection of C_{A} and/or C_{B}, such that PEXT interference is mitigated will not be described in detail herein.

For convenience of illustration and for convenience of explaining the operation and functionality of the crosstalk compensator 200, CA and CB are described as capacitive elements. Capacitive elements CA and CB may be any device which can impart a capacitive effect. For example, but not limited to, a capacitor or a varactor may be used to impart the desired capacitive effect in a crosstalk compensator 200. It is intended that all such capacitive devices employed in a crosstalk compensator 200 be included herein within the scope of this disclosure and to be protected by the accompanying claims for the crosstalk compensator system and method.

### III. Preferred Embodiment Components

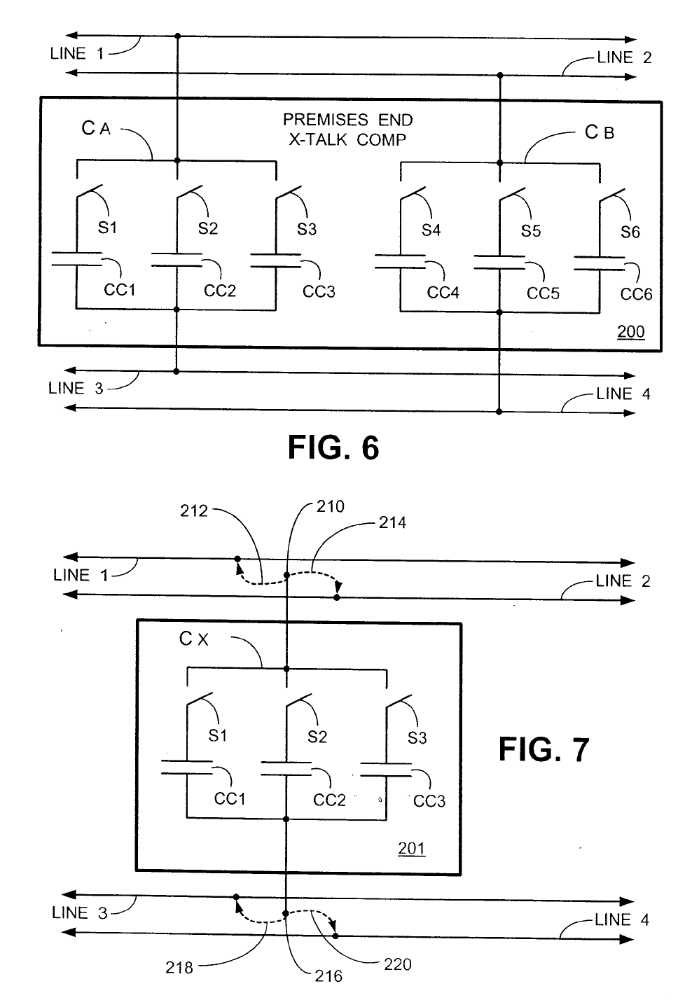

FIG. 6 is a circuit diagram showing components of the preferred embodiment of the crosstalk compensator 200 of FIG. 5. In this preferred embodiment of the crosstalk compensator 200, CA is shown to be a parallel grouping of three compensating capacitors CC1, CC2 and CC3. The compensating capacitors, CC1, CC2 and CC3 would be selected in the preferred embodiment such that either alone or in combination CA can be set to the desired value such that C13 plus CA approximately equals C14, thereby reducing or eliminating the PEXT interference induced by subscriber loop 126 onto line 1 of subscriber loop 128. One skilled in the art will realize that the elements CC1, CC2 and CC3 may be conveniently selected from a plurality of commonly available standardized parts to economically facilitate manufacturing and assembly of a crosstalk compensator 200, or compensating capacitors may be specially manufactured for installation in the crosstalk compensator 200. Furthermore, any number of additional compensating capacitors (CCs), or even less than three CCs, may be employed in alternative embodiments of a crosstalk compensator 200 without departing substantially from the spirit and principle of the crosstalk compensator 200. All such modifications and variations are intended to be included herein within the scope of the crosstalk compensator, and to be protected by the accompanying claims.

CA, as shown in FIG. 6, has three switches S1, S2 and S3. Switch S1 allows compensating capacitor CC1 to be connected between line 1 and line 3. Similarly, switch S2 allows compensating capacitor CC2 to be connected between lines 1 and 3 and switch S3 allows compensating capacitor CC3 to be connected between lines 1 and 3. Thus, the desired value of CA can be approximated by closing switches S1, S2 and/or S3 in a manner such that the desired combination of compensating capacitors CC1, CC2 and CC3 are connected between lines 1 and 3. That is, when C13 is less than C14, CA can be determined such that C13 plus CA is approximately equal to C14, thereby mitigating the impact of PEXT interference from subscriber loop 126 into line 1 of subscriber loop 128.

Additionally, CB is shown to be a parallel grouping of three compensating capacitors CC4, CC5 and CC6 which may be connected between lines 2 and 4 by closing their respective switches S4, S5 and/or S6. Thus, when C24 is less than C23, CB can be determined such that C24 plus CB is approximately equal to C23. That is, one of the compensating capacitors or a combination of the compensating capacitors CC4, CC5 and CC6 may be selected such that PEXT interference induced into line 2 of subscriber loop 128 by communication transmissions over line 126 is mitigated.

The crosstalk compensator 200 of FIG. 6 is shown to have CA connected between line 3 and line 1 and, CB connected between lines 2 and 4. These connections would be made during the initial installation of the crosstalk compensator 200 as described hereinabove in association with FIG. 3. The installer, prior to installation of the crosstalk compensator 200, would conduct a series of tests to determine the degree of mismatch between the mutual coupling capacitance between the electrical conductors of subscriber loop 126 and subscriber loop 128 (see C13, C14, C23 and C24 of FIG. 5). In the illustrative example of FIG. 6, crosstalk compensator 200 is shown to have CA connected between lines 1 and 3. One skilled in the art will realize that in this situation, the installer has determined that C13 is less than C14. In the event that C14 was determined to be less than C13, the installer would connect CA between lines 1 and 4, thereby allowing the operator to insert one or more of the compensating capacitors CC1, CC2 and CC3 between lines 1 and 4 such that C14 plus CA (now connected between lines 1 and 4) is approximately equal to C13.

Likewise, the installer during the installation of crosstalk compensator 200 would determine if the mutual coupling capacitance between line 2 and line 3 (C23) and between line 2 and line 4 (C24) were equal or unequal. If unequal, the installer would determine which of C23 or C24 was the smaller and then connect the crosstalk compensator 200 accordingly. As indicated by the connections of crosstalk compensator 200 shown in FIG. 6, the installer would have determined that C24 was less than C23, thereby connecting CB between lines 2 and 4. Alternatively, if C23 was smaller than C24, the installer would connect the terminals of the crosstalk compensator 200 such that CB was connected between lines 2 and 3.

In the event that the installer determined that C13 was equal to, or sufficiently equal to C14, such that no PEXT interference (or an insignificant amount of PEXT interference) was induced by subscriber line 126 onto line 1 of subscriber loop 128, the installer would not connect CA to subscriber loop 126 and subscriber loop 128 (or alternatively, the installer would not close any of the switches S1, S2 and S3). Likewise, if the installer determined that C23 and C24 were equal or approximately equal such that no PEXT interference (or an insignificant amount of PEXT interference) was introduced from subscriber loop 126 into line 2 of subscriber loop 128, the installer would not connect CB to subscriber loop 126 and subscriber loop 128 (or alternatively, the installer would not close switches S4, S5 and S6).

### IV. First Alternative Embodiment

FIG. 7 shows an alternative embodiment of a crosstalk compensator in accordance with the present invention, which is generally denoted by reference numeral 201. The crosstalk compensator 201 contains only one parallel grouping of compensating capacitors CC1, CC2 and CC3, denoted as CX. During installation of the crosstalk compensator 201, the installer would first determine if there was any significant mismatch between mutual coupling capacitances C13 and C14 (FIG. 5) which would cause undesirable levels of PEXT interference. If there was a significant degree of mismatch between C13 and C14, the installer would determine which was the smaller of C13 and C14. The installer would then connect the crosstalk compensator 201 to the appropriate lines such that undesirable levels of PEXT interference induced from subscriber loop 126 onto line 1 of loop 128 would be mitigated or eliminated. For example, if the installer determined that C13 was less than C14, the installer would connect connection point 210 of the crosstalk compensator 201 to line 1 as shown by the dashed line 212. Also, the installer would connect connection point 216 of the crosstalk compensator 201 to line 3 as shown by the dashed line 218. The installer would select the appropriate combinations of CC1, CC2 and/or CC3 by closing the appropriate switches S1, S2 and/or S3 such that the sum of C13 plus CX was equal to or approximately equal to C14.

Alternatively, if the installer determined that C14 was less than C13, the installer would connect connection point 210 to line 1, as shown by the dashed line 212, and connect connection point 216 to line 4, as shown by the dashed line 220. Thus, the installer could select from the plurality of compensating capacitors CC1, CC2 and CC3 in the above-described manner such that C14 plus CX is equal to or approximately equal to C13.

During the installation process, the installer would also check the coupling of subscriber loop 126 to line 2 of subscriber loop 128. If the installer determined that there was a mismatch between C23 and C24, the installer could connect a second crosstalk compensator 201 in a manner similar as described above to mitigate or eliminate PEXT interference induced from subscriber loop 126 onto line 2 of subscriber loop 128.

Also during the installation process, the installer would check the coupling of subscriber loop 128 to lines 3 and 4 of subscriber loop 126. If the installer determined that there was a mismatch between C13 and C23, such that transmissions over subscriber loop 128 would induce a significant level of PEXT interference into line 3, the installer might connect another crosstalk compensator 201 between lines 1 or 2 of subscriber loop 128 and line 3 of subscriber loop 126 in an appropriate manner to mitigate or eliminate undesirable levels of PEXT interference induced from subscriber loop 128 onto line 3 of subscriber loop 126. The installer would also check the coupling of subscriber loop 128 to line 4 of subscriber 126 to determine if there was a mismatch between C14 and C24. If the mismatch was present and sufficiently great enough to induce PEXT interference into line 4, the installer would install a crosstalk compensator 201 in the manner described hereinabove.

With the first alternative embodiment of crosstalk compensator 201, undesirable levels of PEXT interference may be mitigated with the installation of three crosstalk compensators 201. The installer would first determine which of the mutual coupling capacitances, C13, C14, C23 or C24, was the greatest mutual coupling capacitance. Then, three crosstalk compensators 201 (or a single crosstalk compensator with three compensation capacitor groups) would be connected to the subscriber loops. Compensating capacitors would be selected such that each one of the remaining mutual coupling capacitances would be compensated to be the same magnitude as the largest mutual coupling capacitance. For example, if the installer had determined that C13 was the greatest mutual coupling capacitance, a first crosstalk compensator 201 would be installed in parallel with C14 and the compensating capacitor selected such that C14 plus CX equaled C13. Likewise, a second and a third crosstalk compensator 201 would be installed in a like manner in parallel with mutual coupling capacitances C23 and C24.

### V. Second Alternative Embodiment

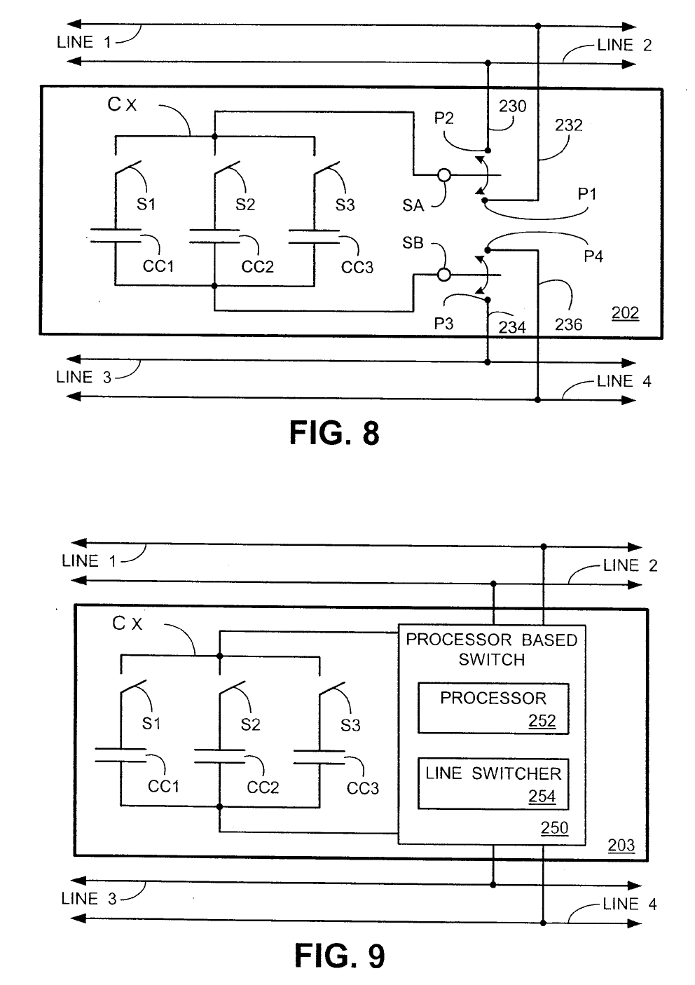

A second alternative embodiment of a crosstalk compensator in accordance with the present invention is illustrated in FIG. 8 and generally denoted by reference numeral 202. This alternative embodiment of the crosstalk compensator 202 is similar to the first alternative embodiment of the crosstalk compensator 201 (FIG. 7) in that only a single group of compensating capacitors CC1, CC2 and CC3 are provided, denoted as CX. With this alternative embodiment of the crosstalk compensator 202, the installer would determine if there was a mutual coupling capacitance mismatch as described hereinabove and then select the compensating capacitors CC1, CC2 and/or CC3 by closing switches S1, S2 and/or S3, respectively such that CX is added to the desired mutual coupling capacitance in the above-described manner to eliminate any undesirable significant PEXT interference.

This alternative embodiment of the crosstalk compensator 202 has two additional line selecting switches, SA and SB. The installer would install the crosstalk compensator 202 to line 1, line 2, line 3 and line 4 as shown by lines 230, 232, 234 and 236, respectively. This alternative embodiment of a crosstalk compensator 202 could be particularly applicable in situations where access to the subscriber loops was readily available through standardized connectors, such as a telephone jack or the like. Then, the installer could select the positions of line selecting switches SA and SB such that CX was added to the appropriate mutual coupling capacitance C13, C14, C23 or C24 (FIG. 5). For example, if the installer desired to connect CX between line 1 and line 3, the installer would set switch SA to the position P1 and, switch SB to the position P3. Thus, it is seen that the installer can select the positions of line selecting switches SA and SB such that the crosstalk compensator 202 can be connected to either line 1 or line 2 of subscriber loop 128 (FIG. 5) and to line 3 or line 4 of subscriber loop 126 (FIG. 5). Specialized connectors could be employed to facilitate the installation of additional crosstalk compensators 202.

Crosstalk compensator 202 compensates for a single mutual coupling capacitance mismatch. If, after the installation of a first crosstalk compensator 202, the installer determines that PEXT interference has not been mitigated to an acceptable level, the installer would conduct further testing to identify any other significant mismatches. The installer would then install as many crosstalk compensators 202 as necessary to mitigate PEXT interference to an acceptable level. As many as three crosstalk compensators 202 may be required to mitigate the possible combinations of mutual coupling capacitance mismatches.

### VI. Third Alternative Embodiment

FIG. 9 illustrates a third alternative embodiment of the crosstalk compensator 203. This third alternative embodiment of the crosstalk compensator 203 is similar to the second alternative embodiment of the crosstalk compensator 202 (FIG. 8) with the addition of a processor-based line selection switch system. This alternative embodiment of the crosstalk compensator 203 of FIG. 9 would be installed in a manner similar to the crosstalk compensator 202 (FIG. 8). However, crosstalk compensator 203 employs a processor-based switch 250 which has at least a processor 252 and line switcher 254. The processor 252 (as well as the other processors described later in this document) can be implemented via, for example but not limited to, a conventional general purpose microprocessor, a specially designed specific application processor, or by other processors typically employed in the arts. Two line switches (not shown), equivalent to line switches SA and SB (FIG. 8), reside in line switcher 254 and are controlled by processor 252. The installer first analyzes the degree of mismatch between the various mutual coupling capacitance C13, C14, C23 and C24 (FIG. 5) to determine the most effective deployment of the grouping of compensating capacitors CC1, CC2 and CC3, denoted by CX, which will mitigate or eliminate PEXT interference. The installer then instructs processor 252 to configure line switcher 254 appropriately. That is, processor 252 and switches residing in line switcher 254 now do the switching functions that the installer manually did with crosstalk compensator 202 (FIG. 8) during the installation process.

The line switching functions performed by SA and SB of the crosstalk compensator 202 (FIG. 8) are now implemented by the automatic line switcher 254 residing in processor-based switch 250. Line switcher 254 may be implemented with any type of electronic, solid state or firmware type switching device or means commonly employed in the art. Such a processor based switch 250 in this alternative embodiment of the crosstalk compensator 203 would be implemented by a combination of software and firmware using components and methods commonly employed in the art of switching electrical devices.

One skilled in the art will realize that the crosstalk compensator 203 compensates for a single mutual coupling capacitance mismatch. If, after the installation of a first crosstalk compensator 203, the installer determines that PEXT interference has not been mitigated to an acceptable level, the installer would conduct further testing to identify any other significant mismatches. The installer would then install as many crosstalk compensators 203 as necessary to mitigate PEXT interference to an acceptable level. As many as three crosstalk compensators 203 may be required to mitigate the possible combinations of mutual coupling capacitance mismatches.

### VII. Fourth Alternative Embodiment

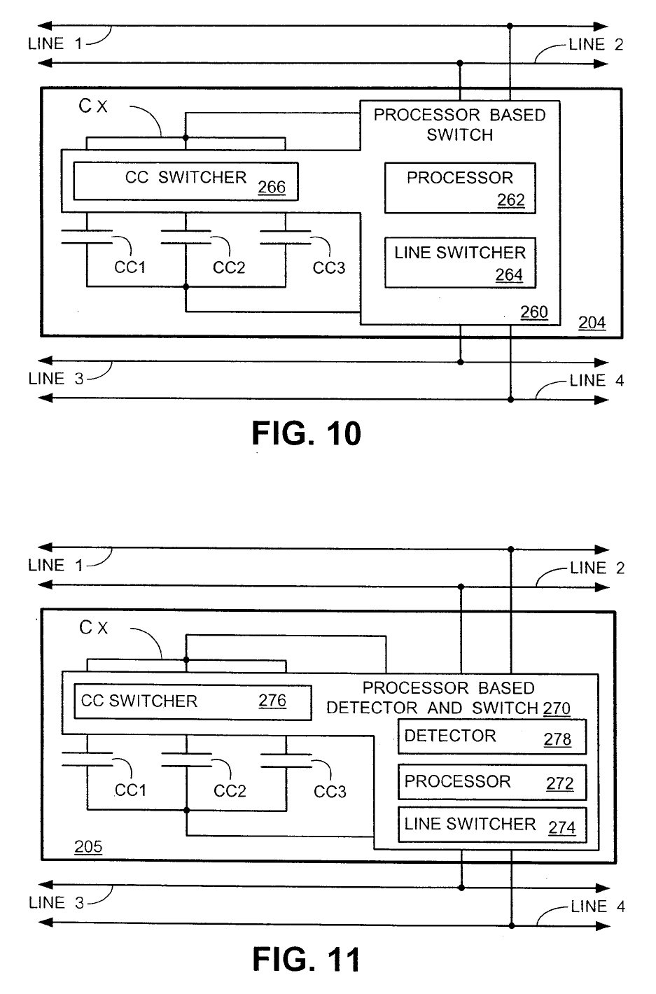

FIG. 10 illustrates a fourth alternative embodiment of the crosstalk compensator 204. This fourth alternative embodiment of the crosstalk compensator 204 is similar to the third alternative embodiment of the crosstalk compensator 203 (FIG. 9) in that the crosstalk compensator 204 has the line switching functions controlled by a processor 262 which controls line switcher 264. Processor 262 and line switcher 264 are substantially similar to the processor 252 and line switcher 264 (FIG. 9). However, this alternative embodiment of the crosstalk compensator 204, shown in FIG. 10, contains a CC switcher 266. Processor 262 would include additional logic to control CC switcher 266. CC switcher 266 has three compensating capacitor switches which are equivalent to S1, S2 and S3 (FIG. 9) which would control the connections of compensating capacitors CC1, CC2 and CC3, respectively. Like the line switches residing in line switcher 254, the compensating capacitor switches residing in CC switcher 266 may be implemented with any type of electronic, solid state or firmware type switching device or means commonly employed in the art. Such a processor-based switch 260 in this alternative embodiment of the crosstalk compensator 204 would be implemented by a combination of software and firmware using components and methods commonly employed in the art of switching electrical devices. The installer would instruct the processor-based switch 260 to make the appropriate switching connections during the installation process.

One skilled in the art will realize that the crosstalk compensator 204 compensates for a single mutual coupling capacitance mismatch. If, after the installation of a first crosstalk compensator 204, the installer determines that PEXT interference has not been mitigated to an acceptable level, the installer would conduct further testing to identify any other significant mismatches. The installer would then install as many crosstalk compensators 204 as necessary to mitigate PEXT interference to an acceptable level. As many as three crosstalk compensators 204 may be required to mitigate the possible combinations of mutual coupling capacitance mismatches.

### VIII. Fifth Alternative Embodiment

FIG. 11 illustrates a fifth alternative embodiment of the crosstalk compensator 205. This fifth alternative embodiment of the crosstalk compensator 205 is similar to the fourth alternative embodiment of the crosstalk compensator 204 (FIG. 10) in that the crosstalk compensator 205 has the line switching functions and the compensating capacitor switching functions controlled by a processor 272 which controls line switcher 274 and CC switcher 276. Processor 272, line switcher 274 and CC switcher 276 are substantially similar to the processor 262, line switcher 264 and CC switcher 266 (FIG. 9). However, this alternative embodiment of the crosstalk compensator 205 shown in FIG. 11 contains a detector 278 as part of the processor based detector and switch 270. With this alternative embodiment, the installer would merely connect the crosstalk compensator 205 to line 1, line 2, line 3 and line 4 as shown in FIG. 11. The detector 278 would then detect the presence of any mismatch in mutual coupling capacitance C13, C14, C23 and/or C24 (FIG. 5) and communicate the mismatch information to the processor 272. Processor 272 would analyze the detected mismatches to determine whether an undesirable significant level of PEXT interference would be present. Processor 272 would then determine the amount of required compensating capacitance to mitigate the identified greatest mismatch and determine the appropriate switch connections for the line switches residing in line switcher 274 and the compensating capacitor switches residing in CC switcher 276. Then, the processor 272 would instruct line switcher 274 and CC switcher 276 connect compensating capacitor group CCX to the appropriate conductors of subscriber lines 126 and 128 such that the PEXT interference caused by the identified greatest mismatch is mitigated. With this alternative embodiment of a crosstalk compensator 205, the single compensating capacitance CCX could only be used to compensate a single mismatch in the above-described mutual coupling capacitance.

Detector 278 could employ any of the well known detection methods or means commonly used in the art of detecting communication signals. For example, but not limited to, the detector may inject signals into inactive wire pairs and monitor PEXT interference in other conductors. Another non-limiting example would detect PEXT interference in an inactive line induced by an active line. Because detection systems and methods which may be employed in a crosstalk compensator are numerous and well understood in the art, a detailed explanation of detection systems are not provided herein. Any suitable detector may be employed in a crosstalk compensator in accordance with the functionality and operation of the present invention. One skilled in the art will appreciate that if other significant mutual coupling capacitance mismatches were present in the system, the installer would install a plurality of crosstalk compensators 205 to mitigate the mismatches.

An alternative embodiment of crosstalk compensator 205 could have additional logic residing in processor 272 to determine the need for the installation of additional crosstalk compensators 205 in the event that a single crosstalk compensator 205 is inadequate to reduce PEXT interference to an acceptable level and to then provide a predefined digital data signal warning alarm or the like to the installer indicating the remaining mismatch(es). Connections may even be employed to connect a plurality of processors 272 residing in a plurality of crosstalk compensators 205 for coordination and communication purposes.

### IX. Sixth Alternative Embodiment

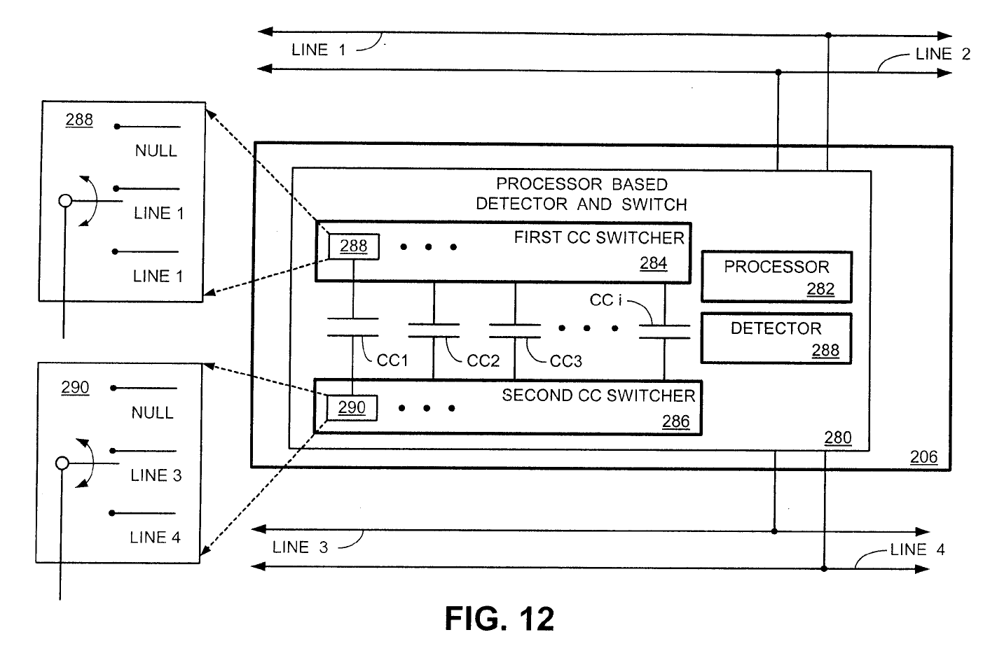

FIG. 12 illustrates a sixth alternative embodiment of the crosstalk compensator 206. This sixth alternative embodiment of the crosstalk compensator 206 is similar to the fifth alternative embodiment of the crosstalk compensator 205 (FIG. 11) in that the crosstalk compensator 206 has a detector 288 which detects the presence of any mismatch in mutual coupling capacitance C13, C14, C23 and/or C24 (FIG. 5). Detector 288 would detect and measure each of the mismatches and communicate the mismatch information to processor 282. Processor 282 would analyze the magnitude of the mismatches to determine if an undesirable significant level of PEXT interference is present. If so, processor 282 would then determine the amount of required compensating capacitance to mitigate each of the identified mismatches.

Crosstalk compensator 206 contains a plurality of compensating capacitors, shown as CC1, CC2, CC3 through CCi. The specific number of compensating capacitors installed in crosstalk compensator 206 would be determined based upon the particular situation for which the crosstalk compensator 206 has been designed for. The crosstalk compensator 206 additionally contains a first CC switcher 284 and a second CC switcher 286 residing in the processor-based detector and switch 280. The first CC switcher 284 contains a plurality of compensating capacitor switches 288 which connect one side of each compensating capacitor (CC1 through CCI) as shown in FIG. 12. Each compensating capacitor switch 288 residing in CC switcher 284 is a three-way switch, or alternatively a combination of switches having the functionality of a three-way switch, such that any individual compensating capacitor (CC1 through CCI) may be connected to either line 1, line 2 or a null position. Similarly, the second CC switcher 286 contains a plurality of three-way compensating capacitor switches 290, or their equivalent, which connects to each compensating capacitor (CC1 through CCI) as shown in FIG. 12. Each three-way compensating capacitor switch 290, or its equivalent, residing in the second CC switcher 286 provides for any individual compensating capacitor (CC1 through CCI) to be connected to either line 3, line 4 or a null position. The status and control of each compensating capacitor switches 288 and 290 residing in the first CC switcher 284 and the second CC switcher 286 is determined and controlled by processor 282.

After detector 288 has provided the mismatch information to processor 282, and after processor 282 has determined the amount of required compensating capacitance to mitigate each of the identified mismatches, processor 282 would select from the plurality of compensating capacitors (CC1 through CCI) the appropriate number and combination of compensating capacitors which most closely approximates the desired amount of compensating capacitance. The processor 282 then controls the first CC switcher 284 and the second CC switcher 286 so that the determined number and combinations of selected compensating capacitors are connected to the appropriate subscriber line conductors (line 1, line 2, line 3 and/or line 4).

An alternative embodiment of the sixth alternative embodiment of the crosstalk compensator 206 may have additional logic within detector 288 to review the degree of compensation after the initial insertion of the compensating capacitors CC1 through CCi. If PEXT interference has not been reduced to an acceptable level, the detector would detect and measure the degree of remaining mismatch and provide the mismatch information to processor 282. The processor 282 would then initiate a second sequence of compensation capacitor switching to further mitigate PEXT interference.

### X. Seventh Alternative Embodiment

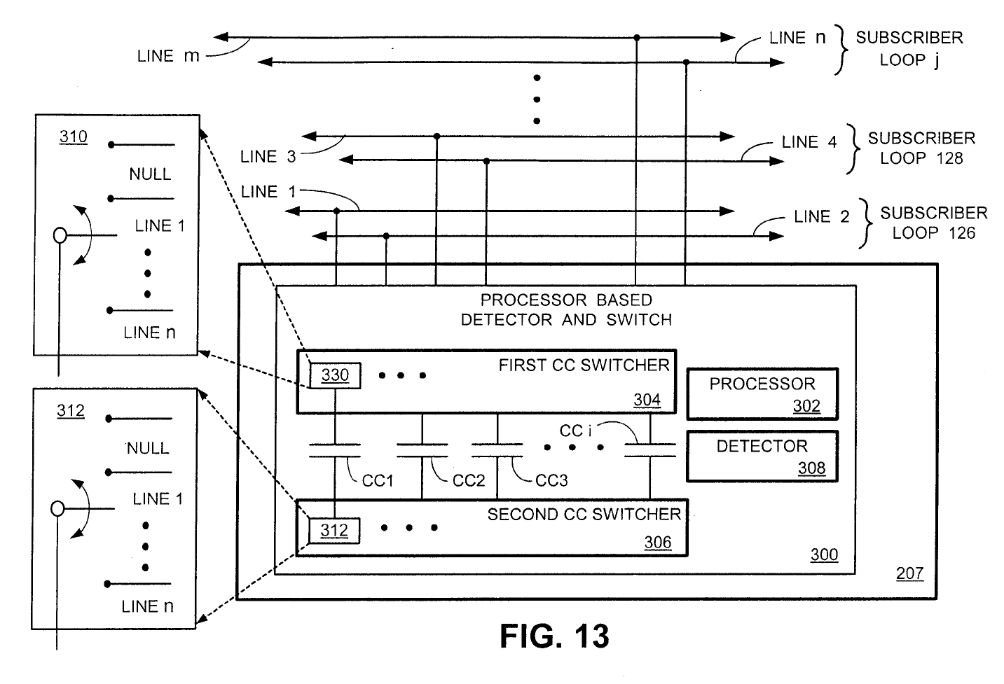

FIG. 13 illustrates a seventh alternative embodiment of the crosstalk compensator 207. This alternative embodiment of crosstalk compensator 207 is similar to the alternative embodiment of the crosstalk compensator 206 (FIG. 12) in that the crosstalk compensator 207 has a processor 302, first CC switcher 304, second CC switcher 306 and detector 308 which are substantially similar to processor 282, first CC switcher 284, second CC switcher 286 and detector 288 (FIG. 12). However, this alternative embodiment of the crosstalk compensator 207, shown in FIG. 13, contains additional logic so that the detector 308 and processor 302 may function in the presence of a plurality of subscriber loops, as described hereinafter. With this alternative embodiment, the installer would merely connect the crosstalk compensator 207 to the plurality of subscriber loops, such as to lines 1 and 2 of subscriber loop 128 (see also FIGS. 3-11), to lines 3 and 4 of subscriber loop 126, and to lines m and n of subscriber loop j, as shown in FIG. 13.

This seventh alternative embodiment of the crosstalk compensator 207 would have a plurality of compensating capacitors CC1 through CCi such that the processor 302 could identify a plurality of mutual coupling capacitance mismatches between a plurality of conductors from a plurality of subscriber loops. Such a processor could analyze a multitude of mutual coupling capacitances and automatically instruct a plurality of capacitor compensating switches 310 and 312 residing respectively in first CC switcher 304 and in second CC switcher 308 to switch in the appropriate groupings of compensating capacitors to mitigate or eliminate PEXT interference that may be present among the plurality of subscriber loops. As shown in FIG. 13, the capacitor compensating switches 310 and 312 are capable of being switched to any of the subscriber loop conductors as determined by logic residing in processor 322. Thus, the crosstalk compensator 207 is seen to have the flexibility of being able to insert any compensating capacitor (CC1-CCi) between any conductor of a subscriber loop as needed to mitigate PEXT interference. This alternative embodiment may be particularly suitable for large office complexes having a number of subscriber loops in parallel running from the service entrance point to a plurality of digital devices, such as PCs and workstations residing in a centralized work area.

### XI. Method for Sixth Alternative Embodiment

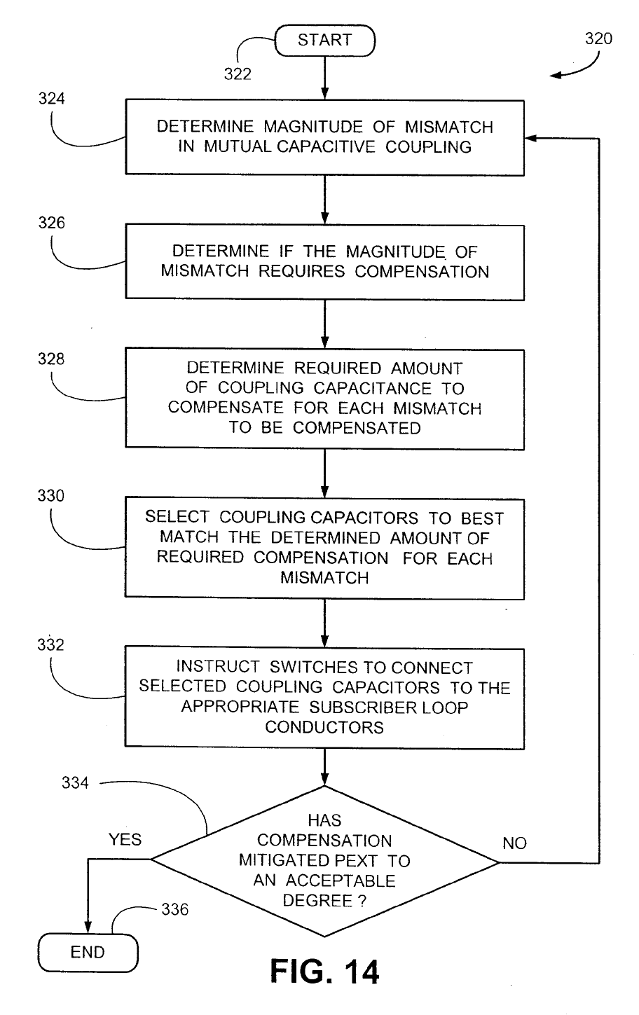

FIG. 14 is a flow chart 320 illustrating the logic residing in processor 302 of crosstalk compensator 207 (FIG. 13). The flow chart of FIG. 14 shows the architecture, functionality, and operation of a possible implementation of the software for implementing the logic residing in processor 302. In this regard, each block may represent a module, segment or portion of code, which comprises one or more executable instructions for implementing the specified logical function(s). It should also be noted that in some alternative implementations, the functions noted in the blocks may occur out of the order noted in FIG. 14 or may include additional functions without departing significantly from the functionality of the crosstalk compensator 207. For example, two blocks shown in succession in FIG. 14 may in fact be executed substantially concurrently, the blocks may sometimes be executed in the reverse order, or some of the blocks may not be executed in all instances, depending upon the functionality involved, as will be further clarified hereinbelow.

The process described in flow chart 320 begins at the start block 322. The logic residing in processor 302 (FIG. 13) determines the magnitude of the mismatch and mutual coupling capacitance as detected by the detector 308 (FIG. 13) as shown at block 324. Then, at block 326, the logic determines if the magnitude of mismatch requires compensation. That is, the logic determines if the detected mismatch is large enough to result in a significant amount of PEXT interference.

Then, at block 328, the logic determines an amount of compensating capacitance to compensate for each mismatch which is to be compensated. The logic then selects compensating capacitors to best match the determined amount of required compensation for each mismatch in block 330. Then, the logic instructs (controls) compensating capacitor switches 310 and 312 (FIG. 13) to connect the selected compensating capacitors to the appropriate subscriber loop conductors. Finally, at block 334, the logic would determine if the compensation has mitigated PEXT interference to an acceptable degree. If not, the process returns to block 324 for another iteration of compensation. If compensation has been inserted such that PEXT interference has been mitigated to an acceptable degree, the process ends at block 336.

One skilled in the art will realize that the process illustrated in FIG. 14 is substantially similar to processes employed by the processors of any of the alternative embodiments of a crosstalk compensator. Any such alternative embodiments of a crosstalk compensator employing a processor which employs a process which may be different from that in FIG. 14 is intended to be included herein within the scope of this disclosure and to be protected by the accompanying claims for the crosstalk compensator. Because the processes employed by alternative embodiments of a crosstalk compensator are substantially similar to the process shown by the flow chart 320 of FIG. 14, such alternative processes are not described in detail for the brevity of this application. One skilled in the art will appreciate that the particular process employed to control the switching of compensating capacitors, and to determine the amount of compensating capacitance required to mitigate PEXT interference to an acceptable degree, may be implemented with a process having additional sub-systems, methods, features and/or advantages not shown in the process of FIG. 14 without departing substantially from the spirit and principles of a crosstalk compensator. Any such alternative embodiments of a crosstalk compensator employing the above-described variations in processor logic are intended to be within the scope of this disclosure and to be protected by the accompanying claims for the crosstalk compensator.

### XII. Computer-Readable Medium Embodiments

Alternative embodiments of a crosstalk compensator may be entirely implemented as software on a computer-readable medium and executed by a processor. Or, alternative embodiments of a crosstalk compensator may have portions implemented as software on a computer-readable medium and executed by a processor, and remaining portions implemented as hardware. For example, the switching function of the crosstalk compensator could be implemented as software and executed as firmware.

In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

### XIII. Alternative Embodiments

The preferred embodiments and alternative embodiments described herein have groups of compensating capacitors which may be connected in parallel with the electrical conductors of subscriber loop 126 (lines 3 and 4) and subscriber loop 128 (lines 1 and 2) (FIGS. 4-13), in a manner as required to mitigate or eliminate PEXT interference. A grouping of three compensating capacitors, CC1, CC2 and CC3, were shown as a matter of convenience and for illustrative purposes only. Alternative embodiments of a crosstalk compensator may have any number of compensating capacitors residing within the crosstalk compensator. Alternative embodiments of a crosstalk compensator could have as few as one compensating capacitor. Furthermore, the functionality and operation of the crosstalk compensator has been described herein for convenience as having compensating capacitors. Alternative embodiments of a crosstalk compensator may employ any device which can impart a capacitive effect. One non-limiting example of a capacitive device is a varactor. Additionally, an alternative embodiment of a crosstalk compensator could employ a variety of capacitive devices. Capacitive elements may also be variable, such as but not limited to, a voltage-variable capacitor, a varactor or a tunable capacitor. Such capacitive devices and variable capacitors having a means for varying the capacitance are well understood in the art, and as such, a detailed explanation of the types and operation of such variable capacitors is not necessary for an understanding of the present invention and is not described herein. The use of a variable capacitor and/or a combination of different capacitive devices would provide for the more accurate setting of the compensating capacitance and/or may accommodate changing environmental conditions. Other alternative embodiments of a crosstalk compensator could have a plurality of compensating capacitors, the number of compensating capacitors residing in the crosstalk compensator being limited only by practical constraints such as construction considerations and economic factors. In such a multi-element configuration of the crosstalk compensator, one (or more) of the elements could be a variable capacitor.

Alternative embodiments of the crosstalk compensator may reduce the above-described mismatches in the mutual coupling capacitances to a predefined threshold. Such a predefined threshold would be determined such that any remaining PEXT interference has been mitigated to an acceptable level. Alternatively, the crosstalk compensator could be constructed such that mutual coupling capacitance mismatches are reduced such that PEXT interference is reduced to at least a pre-defined threshold. Any such alternative embodiments of a crosstalk compensator are intended to be within the scope of this disclosure and to be protected by the accompanying claims for a crosstalk compensator.

Alternative embodiments of the crosstalk compensator having a detector may have the added feature of periodically testing for changes in mutual coupling mismatches which may give rise to PEXT interference. If undesirable PEXT is detected, the crosstalk compensator would adapt the configuration of the compensating capacitors accordingly. For example, the user may reconfigure the premises wiring to a digital device, thereby causing a change in mutual couplings with other subscriber loops. Periodic testing, and adaptation if required, would ensure that undesirable PEXT interference does not become a problem. Periodic testing and adaptation could be initiated by a timing device incorporated into a crosstalk compensator or by a timing device in communication with a crosstalk compensator. Or, periodic testing and adaptation could be initiated by a person such as, but not limited to, a user or a service provider operator. Initiation of testing and adaptation by a person could be done manually or by a communication signal sent to the crosstalk compensator.

Furthermore, alternative embodiments of the crosstalk compensator may use any type of switching scheme to connect the compensating capacitors to the subscriber loop conductors. Such switching schemes are commonly known and employed in the art, in any such variations in a switching scheme to switch compensating capacitors may be implemented in a crosstalk compensator without departing substantially from the spirit, principles and functionality of a crosstalk compensator. Any such alternative embodiments of a crosstalk compensator are intended to be within the scope of this disclosure and to be protected by the accompanying claims for a crosstalk compensator.

Alternative embodiments of a crosstalk compensator may employ resistive and/or inductive elements in addition to capacitive elements. Such an alternative embodiment may be utilized at higher communication frequencies.

Alternative embodiments of a crosstalk compensator are equally applicable to other types of transmitters/receivers or other communication devices wherein PEXT-like interference is present. A crosstalk compensator may also be applicable to other electronic and/or electrical devices to mitigate PEXT-like interference. For example, telephones 30 (FIG. 3) or any of the various digital equipment commonly available today (or in the future) may be subject to PEXT interference and have a crosstalk compensator implemented therein. Likewise, other communication mediums, which may be either analog or digital, may employ receivers wherein portions of the transmission system give rise to PEXT-like interference which would be suitable for mitigation by a crosstalk compensator. Examples of such communication mediums include, but are not limited to, microwave, satellite, radio frequency (RF), power line carrier or coaxial cable. Any such alternative embodiments of a crosstalk compensator implemented in such equipment are intended to be within the scope of this disclosure and be protected by the accompanying claims for the crosstalk compensator.

It should be emphasized that the above-described embodiments of the crosstalk compensator, particularly, any “preferred” embodiments, are merely possible examples of implementations, merely set forth for a clear understanding of the principles of the crosstalk compensator. Many variations and modifications may be made to the above-described embodiment(s) of the crosstalk compensator without departing substantially from the spirit and principles of the crosstalk compensator. All such modifications and variations are intended to be included herein within the scope of this disclosure and the crosstalk compensator and protected by the following claims.

At least the following is claimed:

1. A system for reducing crosstalk in a communication network comprising:
at least one group of crosstalk compensation devices, the group having a plurality of crosstalk compensation devices, the group coupled to one of a plurality of conductor pairs; and
a plurality of switches, each switch operative when activated to connect at least one of the crosstalk compensation devices in the group in parallel with one of the conductor pairs, such that crosstalk, caused by a mismatch beween mutual capacitive couplings associated with the conductors in the pair, is reduced.

2. The system of claim 1, wherein the at least one group of crosstalk compensation devices comprises a plurality of groups of crosstalk compensation devices, each group having a plurality of compensation devices, each group coupled to one of a plurality of conductor pairs, wherein each of the switches is operative when activated to connect one of the crosstalk compensation devices in one of the groups in parallel with one of the conductor pairs.

3. The system of claim 1, wherein at least one of the plurality of crosstalk compensation devices is a capacitor.

4. The system of claim 1, wherein at least one of the plurality of crosstalk compensation devices is a varactor.

5. The system of claim 1, wherein the plurality of conductor pairs are located in a customer premises portion of a subscriber loop.

6. The system of claim 1, wherein one of the conductors in the one conductor pair is located a customer premises portion of a first subscriber loop and the other conductor in the one conductor pair is located in a customer premises portion of a second subscriber loop.

7. The system of claim 1, further comprising a processor, wherein activation of each of the plurality of switches is under control of the processor.

8. The system of claim 1, further comprising:
a processor configured to control activation of each of the plurality of switches; and
a crosstalk detector configured to detect the mismatch,
wherein the processor activates one of the plurality of switches in response to a detected mismatch.

9. The system of claim 1, further comprising:
a second plurality of switches, each switch in the second plurality operative when activated to connect the group of crosstalk compensation devices to a corresponding pair of the plurality of conductor pairs,
wherein the plurality of switches is further operative when activated to connect one of the crosstalk compensation devices in parallel with the one conductor pair.

10. A method for reducing crosstalk comprising:
detecting crosstalk between a first conductor and a second conductor, the first conductor in a customer premises portion of a first subscriber loop and the second conductor in a customer premises portion of a second subscriber loop;
selecting at least one crosstalk compensation device to reduce the crosstalk, the device selected from a group of such devices, the group connected to the first and the second conductor; and
connecting the selected crosstalk compensation device in parallel with the first and the second conductor.

11. The method of claim 10, further comprising:
selecting at least one crosstalk compensation device to reduce the near end crosstalk to a predefined threshold, the device selected from a group of such devices, the group connected to the first and the second conductor.

12. The method of claim 10, wherein the at least one crosstalk compensation device is a capacitor.

13. The method of claim 10, wherein the at least one crosstalk compensation device is a varactor.

14. The method of claim 10, further comprising:
selecting one pair of a plurality of conductor pairs; and
connecting the selected crosstalk compensation device in parallel with the selected pair of conductors.

15. A system for reducing crosstalk comprising:
means for detecting crosstalk between a first conductor and a second conductor;
means for selecting at least one crosstalk compensation device to reduce the crosstalk, the device selected from a group of such devices, the group connected to the first and the second conductor; and
means for connecting the selected crosstalk compensation device in parallel with the first and the second conductor.

16. The system of claim 15, wherein the crosstalk is premises end crosstalk (PEXT).

17. The system of claim 15, wherein the first and second conductors are located a customer premises portion of a subscriber loop.

18. The system of claim 15, wherein the first conductor is located a customer premises portion of a first subscriber loop and the second conductor in a customer premises portion of a second subscriber loop.

19. The system of claim 15, further comprising:
means for selecting at least one crosstalk compensation device to reduce the near end crosstalk to a predefined threshold, the device selected from a group of such devices, the group connected to the first and the second conductor.

20. The system of claim 15, further comprising:
means for selecting one pair of a plurality of conductor pairs; and
means for connecting the selected crosstalk compensation device in parallel with the selected pair of conductors.
